(19) United States
(12) Patent Application Publication
(10) Pub. No.: US 2019/0302390 A1
(43) Pub. Date: Oct. 3, 2019

(54) HORIZONTAL PRECISION ADJUSTMENT AND LOCKING DEVICE

(71) Applicant: The Institute of Optics and Electronics, The Chinese Academy of Sciences, Chengdu, (CN)

(72) Inventors: Xianchang ZHU, Chengdu (CN); Jian WANG, Chengdu (CN); Lei CHEN, Chengdu, Sichuan (CN)

(21) Appl. No.: 16/368,308

(22) Filed: Mar. 28, 2019

(30) Foreign Application Priority Data
Mar. 28, 2018 (CN) 201810262324.0

(51) Int. Cl. G02B 7/00; G02B 27/64

(52) U.S. Cl. CPC G02B 7/003; G02B 27/646

(57) ABSTRACT

A horizontal precision adjustment and locking device can be used for online fine adjustment and locking fixation of optical components in a precision optical system. A bilaterally symmetric parallelogram hinge is designed in the disclosure, in which the parallelogram hinge deforms under a driving force to realize the adjustment of the components to be adjusted. Two circles of identical adjustment devices are designed on the same pushing adjustment plate to achieve independent adjustments in horizontal directions, including X axis and Y axis, while simplifying the adjustment device. Each of the parallelogram hinges is adjusted by a thread pair at one end of the adjustment and locking device, and the adjustment and self-locking of the adjustment and locking device is obtained by a pushing force from the thread pair and a reaction force from the hinge.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### BACKGROUND OF THE INVENTION

### Field of the Invention

The disclosure relates to a horizontal adjustment and locking device, which belongs to a field of precision machinery and can be used for precision adjustment of optical components in various high-precision imaging optical systems.

### Description of the Related Art

With the improvement of the performance of optical imaging systems, further requirements are put forward on the adjustment function of optical components. That is, not only the adjustment precision of the optical components is required up to micron or even sub-micron level; but also higher requirements on the dynamic response time of the adjustment device is put forward. At the same time, the adjustment device is required to be more compact in spatial size.

In an optical imaging system, a common adjustment to the position of the optical component relates to an adjustment in horizontal directions, including X axis and Y axis. In order to realize the horizontal adjustment of specific optical components in the optical imaging system, the existing adjustment structures mostly employ linear guide rails to realize the adjustment, and are driven by means of a precision hand wheel which may be returned and tracked by a tension spring. Such structures can achieve a high precision adjustment, but there are certain constrains in adjusting some specific system. Firstly, in order to obtain independent adjustments along X and Y axes, two layers of independent linear guide rail devices are required, and the high-precision adjustment system puts forward high requirements for orthogonality of the two-layer linear guide rails. Secondly, the linear guide rails require additional devices to be locked, which leads to a complexity of the entire adjustment device. Finally, rolling balls between guide rails and sliders are employed to realize displacement adjustment of the linear guide rail adjustment device. In some special systems, the iron filings caused by the ball friction and lubrication reagents can affect the system imaging.

### SUMMARY OF THE INVENTION

In order to address the above technical problem regarding displacement adjustment of the optical component in the horizontal direction, an X/Y direction adjustment device based on parallelogram hinges is provided in the present disclosure to realize a horizontal adjustment of a specific optical element in a relatively compact space. The adjustment device of the disclosure has a self-locking function, realizing self-locking of the device with a high-precision adjustment in the X/Y direction and ensuring the stability of the adjustment device.

The technical solutions of the present disclosure are as follows: A horizontal precision adjustment and locking device, wherein in the adjustment and locking device, two circles of independent parallelogram hinges, including a X-direction adjustment device and a Y-direction adjustment device, are processed on an adjustment plate to realize independent adjustments in X and Y directions, and wherein the adjustment and locking device utilizes two parallelogram hinges, each of which is symmetric with respect to both a X axis and a Y axis, to form a hinge deformation adjustment device such that a guiding is achieved while the adjustment is performed, ensuring orthogonality and independence of adjustment of the adjustment and locking device in the X/Y direction. Each of the parallelogram hinges is adjusted by a thread pair at one end of the adjustment and locking device, and the adjustment and self-locking of the adjustment and locking device is obtained by a pushing force from the thread pair and a reaction force from the hinge.

The thread pair and a jackscrew are used to adjust the adjustment and locking device so as to cause the corresponding parallelogram hinge to deform. Since the hinge is completely symmetrical on two sides, the deformation amounts of four articulated portions of the parallelogram hinge are consistent with each other under an action of the adjusting force, so that a position adjustment along the horizontal axis occurs in the adjustment and locking device.

Symmetrical distribution of each of the parallelogram hinges on two sides of the adjustment axes, including X axis and Y axis, is ensured by machining. When the adjustment and locking device is in a free state, each of the parallelogram hinges extends completely along the adjustment axis of X/Y direction; and when the thread pair and the jackscrew are used to apply a driving force to the adjustment and locking device, a same deformation occurs in the four articulated portions of each of the symmetrically-distributed parallelogram hinges on both sides of the X/Y axis, and the adjustment and locking device is deformed in a direction of the X/Y axis to achieve the horizontal adjustment.

The advantages of the present disclosure over the prior art are as follows:

(1) the horizontal adjustment and locking device adopts two symmetrical parallelogram hinges, and the whole horizontal adjustment and locking device is ensured to move along a single axis during the adjustment process, and no additional adjustment error is introduced; and

(2) the horizontal adjustment and locking device adopts a two-circle adjustment device, including the inner circle adjustment device and the outer circle adjustment device, to separate the X-axis adjustment from the Y-axis adjustment, such that high-precision adjustment in the X/Y direction can be independently performed.

### BRIEF DESCRIPTION OF THE DRAWINGS

FIG. 1 is a schematic view of a horizontal precision adjustment and locking device of the present disclosure;

FIG. 2 is a schematic view showing the principle of driving adjustment of the hinge of the present disclosure;

FIG. 3 is a schematic view showing deformation of the hinge of the present disclosure in an actual adjustment.

### DETAILED DESCRIPTION OF THE PREFERRED EMBODIMENT

The adjustment device of the present disclosure will be further described with reference to the accompanying drawings.

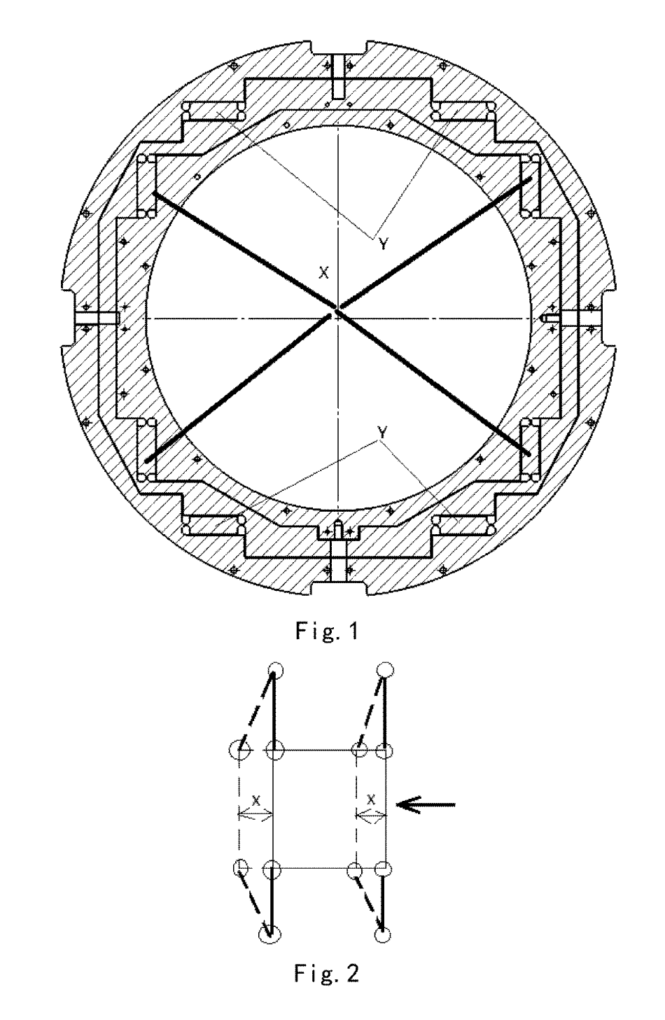

FIG. 1 is a schematic view showing the principle of a horizontal adjustment and locking device based on deformation of parallelogram hinge according to the present disclosure. In the horizontal precision adjustment and locking device referred to in the present disclosure, two circles of independent parallelogram hinges, including a X-direction adjustment device and a Y-direction adjustment device, are processed on an adjustment plate to realize independent adjustments in X and Y directions. As shown in FIG. 1, an inner circle X-direction adjustment device is composed of four articulated portions symmetrically distributed perpendicular to the X-axis. When the X-direction adjustment device is in an initial position, the four articulated portions form a rectangle, and when a driving force is applied, the four articulated portions form a parallelogram to realize the X-direction adjustment. Similarly, an outer circle Y-direction adjustment device is composed of four articulated portions symmetrically distributed perpendicular to the Y-axis, and the Y-direction adjustment is performed similar to the X-direction adjustment.

As shown in FIG. 1, each of the parallelogram hinges is adjusted by a thread pair at one corresponding side of the adjustment and locking device, and the adjustment and self-locking of the adjustment and locking device is obtained by a pushing force from the thread pair and a reaction force from the hinge. Since the hinge is completely symmetrical on two sides, the deformation amounts of the four articulated portions of the parallelogram hinge are consistent with each other under an action of the adjusting force, so that position adjustments along the horizontal axis X and the vertical axis Y occur in the adjustment and locking device.

As shown in FIG. 1, in the adjustment and locking device, symmetrical distribution of the four articulated portions of each of the parallelogram hinges on two sides of the adjustment axes, i.e. X axis and Y axis, is ensured by machining. When the adjustment and locking device is in a free state, each of the parallelogram hinges extends completely along the adjustment axis of X/Y direction, as shown by the solid lines in FIG. 2; and when the thread pair and the jackscrew are used to apply a driving force to the adjustment and locking device, a same deformation occurs in the four articulated portions of each of the symmetrically-distributed parallelogram hinges on both sides of the X/Y direction, and the adjustment and locking device is deformed in a direction of the X/Y axis to achieve the horizontal adjustment in the direction of the X/Y axis, as shown by the dashed lines in FIG. 2.

FIG. 2 is a schematic view showing the principle of driving adjustment of the hinge in the adjustment and locking device according to the present disclosure. The hinges are each completely symmetrically distributed, taking the X-direction adjustment as an example, as shown in FIG. 2: when the driving force acts on the hinge, the four articulated portions of the symmetrically-distributed parallelogram hinge will produce a same amount of deformation due to the same force arm, and the displacement adjustment of the adjustment and locking device along a direction of the driving force, i.e. X direction, is achieved.

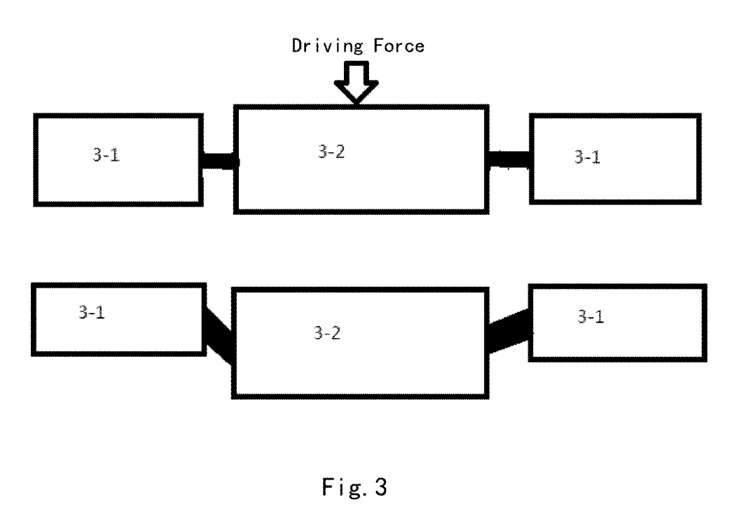

Specifically, the horizontal adjustment and locking device is processed into four circles by wire cutting. From the outer side to the inner side, the first circle is used for fixing and connecting the entire adjustment and locking device with external devices by virtue of screw holes; the second circle is used for the Y-axis adjustment, composed of four articulated portions symmetrically distributed with respect to the X-axis in two-to-two correspondence, and the specific structure of the deformation hinge is shown as in FIG. 3; the third circle is used for the X-axis adjustment, composed of four articulated portions symmetrically distributed with respect to the Y-axis in two-to-two correspondence; the fourth circle is used for fixing the component to be adjusted by virtue of screws.

As shown in FIG. 3, the reference numeral 3-1 denotes a fixed hinge member, and the reference numeral 3-2 denotes a deforming member. When subjected to an external driving force, the symmetrically-distributed parallelogram hinge produces a symmetrical deformation, thereby achieving horizontal adjustments of the adjustment and locking device.

What is claimed is:

1. A horizontal precision adjustment and locking device,
wherein in the adjustment and locking device, two circles of independent parallelogram hinges comprising a X-direction adjustment device and a Y-direction adjustment device are processed on an adjustment plate to realize independent adjustments in X and Y directions;
wherein the adjustment and locking device utilizes two parallelogram hinges, each of which is symmetric with respect to both a X axis and a Y axis, to form a hinge deformation adjustment device such that a guiding is achieved while the adjustment is performed, ensuring orthogonality and independence of adjustment of the adjustment and locking device in the X/Y direction; and
wherein each of the parallelogram hinges is adjusted by a thread pair at one end of the adjustment and locking device, and adjustment and self-locking of the adjustment and locking device is obtained by a pushing force from the thread pair and a reaction force from the hinge.

2. The horizontal precision adjustment and locking device according to claim 1,
wherein the thread pair and a jackscrew are used to adjust the adjustment and locking device so as to cause the corresponding parallelogram hinge to deform, and since the hinge is completely symmetrical on two sides, deformation amounts of four articulated portions of the parallelogram hinge are consistent with each other under an action of the adjusting force, so that a position adjustment along the horizontal axis occurs in the adjustment and locking device.

3. The horizontal precision adjustment and locking device according to claim 1,
wherein symmetrical distribution of four articulated portions of each of the parallelogram hinges on two sides of the adjustment axes, including X axis and Y axis, is ensured by machining;
wherein when the adjustment and locking device is in a free state, each of the parallelogram hinges extends completely along the adjustment axis of X/Y direction; and
wherein when the thread pair and the jackscrew are used to apply a driving force to the adjustment and locking device, a same deformation occurs in the symmetrically-distributed parallelogram hinge on both sides of the X/Y axis, and the adjustment and locking device is deformed in a direction of the X/Y axis to achieve the horizontal adjustment.
